(19) United States
(12) Patent Application Publication
(10) Pub. No.: US 2019/0110619 A1
(43) Pub. Date: Apr. 18, 2019

(54) Manual device for maxdimizing application of butter to an ear of corn

(71) Applicant: Myles Wittenstein, New York City, NY (US)

(72) Inventor: Myles Wittenstein, New York City, NY (US)

(21) Appl. No.: 15/732,253

(22) Filed: Oct. 16, 2017

(51) Int. Cl. A47G 19/00; A47J 9/00

(52) U.S. Cl. CPC A47G 19/303; A47J 9/001

(57) ABSTRACT

A manual device maximizing application of butter to an ear of corn. The manual device includes a bottom portion, a top portion, and a butter applicator. The bottom portion rests on a support surface, carries the butter, and rotatably carries the ear of corn. The butter applicator is rotatably connected in the bottom portion, maximizes the application of the butter to the ear of corn when the butter applicator is rotated, which in turn rotates the ear of corn. The top portion is optional and when used is operatively connected to the bottom portion, is for maintaining the ear of corn in the bottom portion during rotation, and prevents the butter from splashing during rotation.

### BACKGROUND OF THE INVENTION

### Field of the Invention

The embodiments of the present invention relate to a manual device for applying butter to an ear of corn, and more particularly, the embodiments of the present invention relate to a manual device for maximizing application of butter to an ear of corn.

### Description of the Prior Art

Numerous innovations for corn butterers have been provided in the prior art, which will be described below in chronological order to show advancement in the art, and which are incorporated herein by reference thereto. Even though these innovations may be suitable for the specific individual purposes to which they address, however, they differ from the embodiments of the present invention in that they do not teach a manual device for maximizing application of butter to an ear of corn.

### U.S. Pat. No. 2,808,020 to Avidson

U.S. Pat. No. 2,808,020—issued to Avidson on Oct. 1, 1957 in U.S. class 118 and subclass 13—teaches a device for applying butter to corn-on-the-cobb which includes a self-supporting receptacle molded in one-piece and having upstanding side and end walls adapted to rest on a supporting surface, and a bottom wall formed integrally with the side and end walls and joined with the latter at a point spaced above the lower edge thereof. The bottom wall has side and end portions downwardly and inwardly from the side and end walls and define an elongated shallow trough. Further included is an elongated roller rotatably mounted in the end walls to have the periphery thereof extend into closely spaced adjacency to the bottom wall and adapted to pick up butter from the receptacle and apply the butter to an ear of corn. The roller has a longitudinally concave portion intermediate the ends thereof. The radius of the roller is small as compared to the radius of curvature of the longitudinally concave portion. The concave portion has grooves formed in the periphery thereof and extending longitudinally of the roller to spread the butter along the concave portion. The end portions of the roller tapering from the intermediate portion inwardly toward the ends of the roller. The upper edge of the side walls curving downwardly to a point below the level of the concave intermediate portion of the roller to form a guide for maintaining an ear of corn centered on the concave portion of the roller.

### U.S. Pat. No. 3,362,777

U.S. Pat. No. 3,362,777—issued to Keshock on Jan. 9, 1968 in U.S. class 401 and subclass 12—teaches a butter applicator including a highly heat conductive material, including an opening along its length for the passages of butter therethrough and a pair of applicator portions extending laterally from the opening for applying butter to an ear of corn.

### U.S. Pat. No. 3,736,152 to Turner

U.S. Pat. No. 3,736,152—issued to Turner on May 29, 1973 in U.S. class 99 and subclass 100 R—teaches a method of buttering corn ears, which includes a container having heated water with melted butter floating on the surface thereof. The corn ears are inserted in each of a plurality of pairs of ring supports mounted on a rotatable shaft disposed across the top of the container. The shaft is then rotated whereby the corn ears are successively immersed in, and withdrawn from, the fluid butter and each corn ear is caused to rotate about its own axis while being passed through the fluid butter.

### U.S. Pat. No. 4,301,762 to Burnett, Jr.

U.S. Pat. No. 4,301,762—issued to Burnett, Jr. On Nov. 24, 1981 in U.S. class 118 and subclass 16—teaches a corn buttering device for applying a coating of butter or butter substitute to an ear of corn, which includes a pan for containing a heated liquid and a receptacle mounted in the pan for containing liquid butter. The pan is provided with a cover that has a recessed upper surface for receiving and supporting an ear of corn therein. The recess in the cover is provided with an elongate slot that communicates with the butter receptacle when the cover is moved downwardly to tilt the receptacle and cause butter to pour through the recess slot and contact an ear of corn. The recess slot is normally closed by a movable wall member that is displaced from the slot during downward movement of the cover on the pan. The cover containing an ear of corn therein is maintained in an upper position on the pan until manually displaced to a lowermost position for applying butter to the corn.

### U.S. Pat. No. 5,858,089 to Martinovic

U.S. Pat. No. 5,858,089—issued to Martinovic on Jan. 12, 1999 in U.S. class 118 and subclass 13—teaches a corn-buttering tool including a stainless mesh screen that secures and cradles the corn, one butter bin—accommodating up to 1 lb. of butter, and one plastic cover that keeps the butter fresh. The butter is placed into the bin, the mesh is set upon the butter, and the heated corn rests on the mesh. Rotating the corn on the mesh attains the desired amount of butter. Combining rotating and sideways motion allows more butter to be applied to the corn. The bin's arched shaped base allows for maximum butter usage. The side lip of same prevents excess melted butter from spilling over.

### International Patent Application Publication Number WO2001041935A to James

International Patent Application Publication Number WO2001041935A—published to James on Jun. 14, 2001 in International class B05B3 and subclass 02—teaches an applicator for applying a fluid to a surface, which includes a frame, an applicator roller, such as a cylindrical brush, rotatably mounted in the frame, and a fluid pick-up roller rotatably mounted in the frame. The pick-up roller is positioned beneath and parallel or substantially parallel to the applicator roller and in contact or near contact with the applicator roller. Further, a reservoir is positioned beneath the pick-up roller. The applicator still further includes a skimmer that is located parallel or substantially parallel to at least part of the pick-up roller.

### British Patent Application Publication Number BG 2419554A to Dominey

British Patent Application Publication Number BG 2419554A—published to Dominey on May 3, 2006 in British class B05C1 and subclass 0813—teaches a sandwich buttering machine that includes a hopper containing butter that is to be deposited on slices of bread via an applicator roller. A regulator roller is used to control the thickness of the butter being deposited, and the position of the roller is adjustable by operation of a screw. The thickness of the butter may be further regulated by altering the relative speeds of rotation of the rollers.

It is apparent that numerous innovations for corn butterers have been provided in the prior art that are adapted to be used. Furthermore, even though these innovations may be suitable for the specific individual purposes to which they address, however, they would not be suitable for the purposes of the embodiments of the present invention as heretofore described, namely, a manual device for maximizing application of butter to an ear of corn.

### SUMMARY OF THE INVENTION

Thus, an object of the embodiments of the present invention is to provide a manual device for maximizing application of butter to an ear of corn, which avoids the disadvantages of the prior art.

Briefly stated, another object of the embodiments of the present invention is to provide a manual device maximizing application of butter to an ear of corn. The manual device includes a bottom portion, a top portion, and a butter applicator. The bottom portion rests on a support surface, carries the butter, and rotatably carries the ear of corn. The butter applicator is rotatably connected in the bottom portion, maximizes the application of the butter to the ear of corn when the butter applicator is rotated, which in turn rotates the ear of corn. The top portion is optional and when used is operatively connected to the bottom portion, is for maintaining the ear of corn in the bottom portion during rotation, and prevents the butter from splashing during rotation.

The novel features considered characteristic of the embodiments of the present invention are set forth in the appended claims. The embodiments of the present invention themselves, however, both as to their construction and to their method of operation together with additional objects and advantages thereof will be best understood from the following description of the specific embodiments when read and understood in connection with the accompanying figures of the drawing.

### BRIEF DESCRIPTION OF THE FIGURES OF THE DRAWING

The figures of the drawing are briefly described as follows:

FIG. 1 is a diagrammatic perspective view of the manual device of the embodiments of the present invention maximizing application of butter to an ear of corn;

FIG. 2 is a diagrammatic perspective view similar to FIG. 1 of the manual device of the embodiments of the present invention with the top portion off;

FIG. 3 is a diagrammatic perspective view of the manual device of the embodiments of the present invention shown in FIGS. 1 and 2 and opened to show the interior;

FIG. 4 is a diagrammatic perspective view of the bottom portion of the manual device of the embodiments of the present invention identified by ARROW 4 in FIG. 3;

FIG. 5 is a diagrammatic perspective view of the bottom portion of the manual device of the embodiments of the present invention taken in the direction of ARROW 5 in FIGS. 1 and 2;

FIG. 6 is a diagrammatic perspective view of the bottom portion of the manual device of the embodiments of the present invention taken in the direction of ARROW 6 in FIGS. 1 and 2; and

FIG. 7 is a diagrammatic perspective view of the exterior surface of the top portion of the manual device of the embodiments of the present invention identified by ARROW 7 in FIG. 3.

### LIST OF REFERENCE NUMERALS UTILIZED IN THE FIGURES OF THE DRAWING

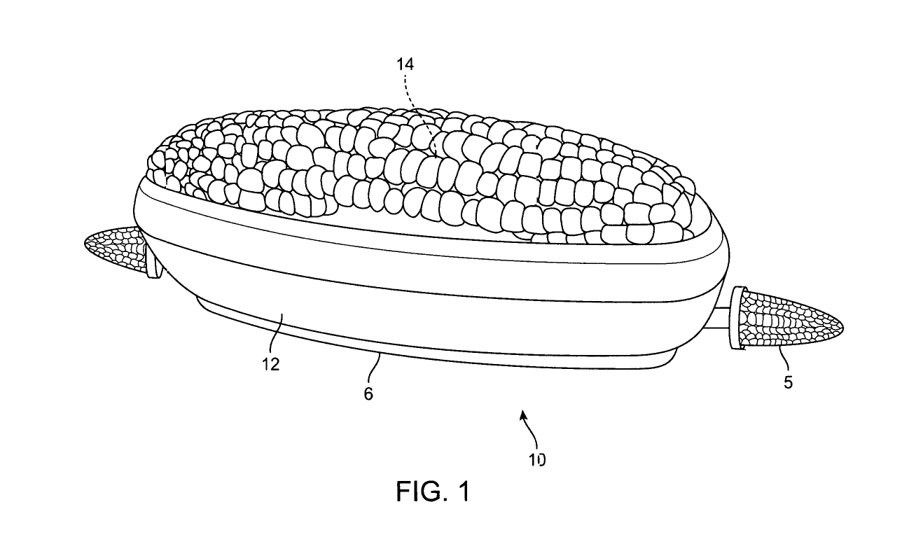

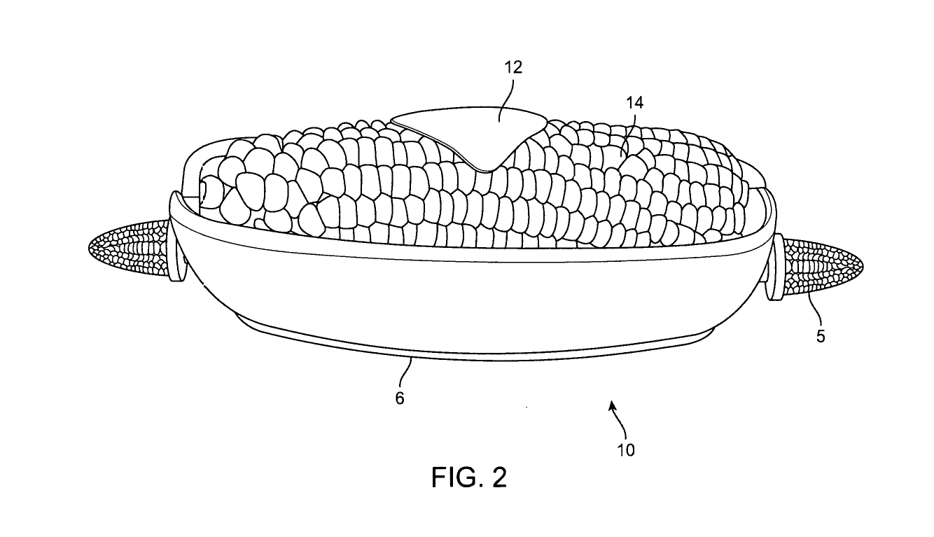

### Introductory—FIGS. 1 and 2

10 manual device of embodiments of present invention for maximizing application of butter 12 to ear of corn 14
12 butter
14 ear of corn

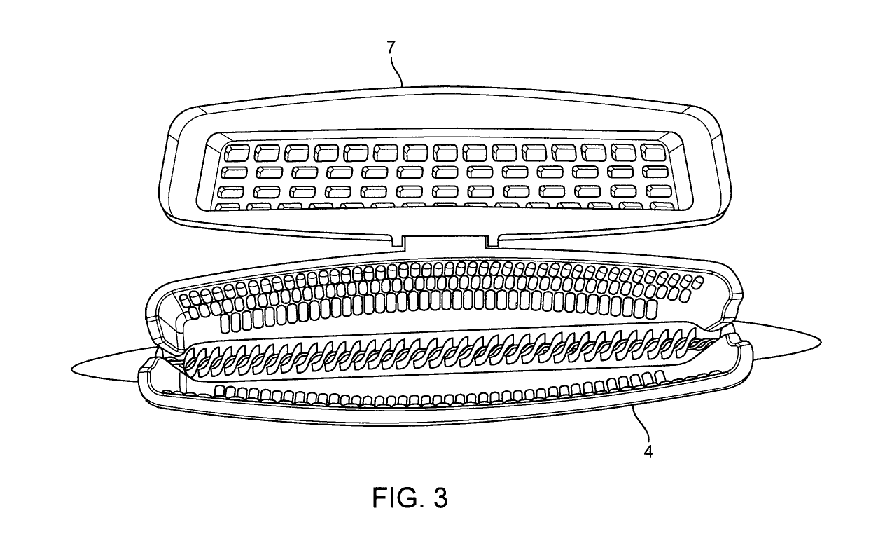

### Overall Configuration of Manual Device 10—FIG. 3

16 bottom portion for resting on support surface 22, for carrying butter 12, and for rotatably carrying ear of corn 14
18 top portion for maintaining ear of corn 14 in bottom portion 16 during rotation, and for preventing butter 12 from splashing out of manual device 10 during rotation
20 butter applicator for maximizing application of butter 12 to ear of corn 14 when butter applicator 20 is rotated, which in turn rotates ear of corn 14
22 support surface

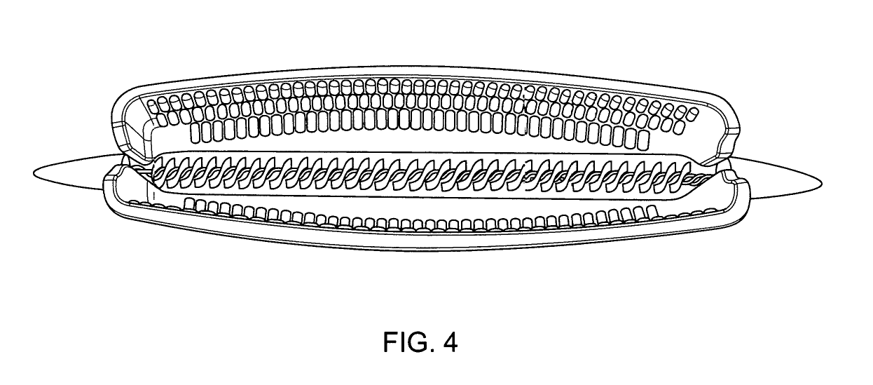

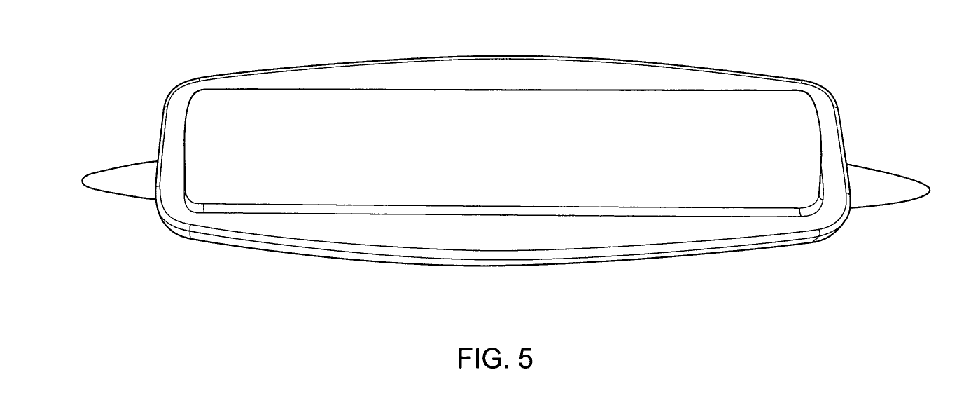

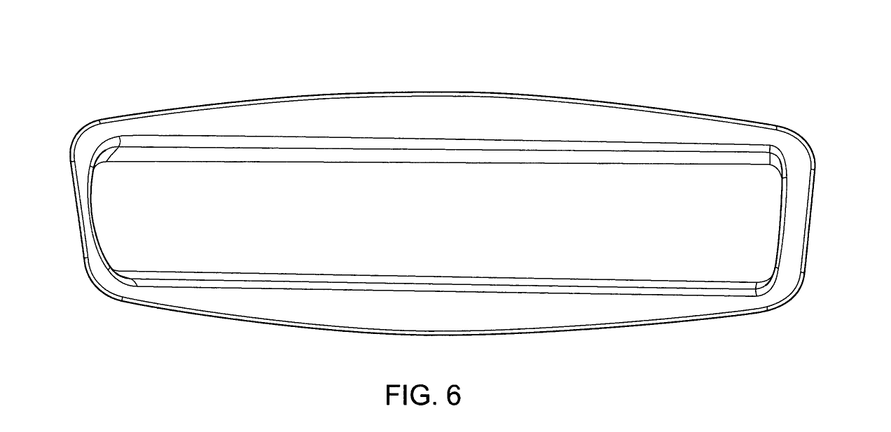

### Specific Configuration of Bottom Portion 16—FIGS. 4, 5, and 6

24 main part of bottom portion 16
26 male flange of bottom portion 16
28 perimeter of main part 24 of bottom portion 16
30 interior surface of main part 24 of bottom portion 16
31 trough of lower part of interior surface 30 of main part 24 of bottom portion 16 for carrying butter 12
32 pair of opposing ends of bottom portion 16
34 through slot of each opposing end of pair of opposing ends 32 of bottom portion 16
36 protrusions of upper part of interior surface 30 of main part 24 of bottom portion 16 for allowing ear of corn 14 to be more uniformly buttered
38 spacings between protrusions of upper part of interior surface 30 of main part 24 of bottom portion 16 for facilitating greater contact with ear of corn 14

### Specific Configuration of Butter Applicator 20—FIGS. 3, 4, and 5

40 brush of butter applicator 20 for disposing in butter 16
42 pair of laterally compressed ends of brush 40 of butter applicator 20, respectively
44 pair of handles of butter applicator 20, respectively

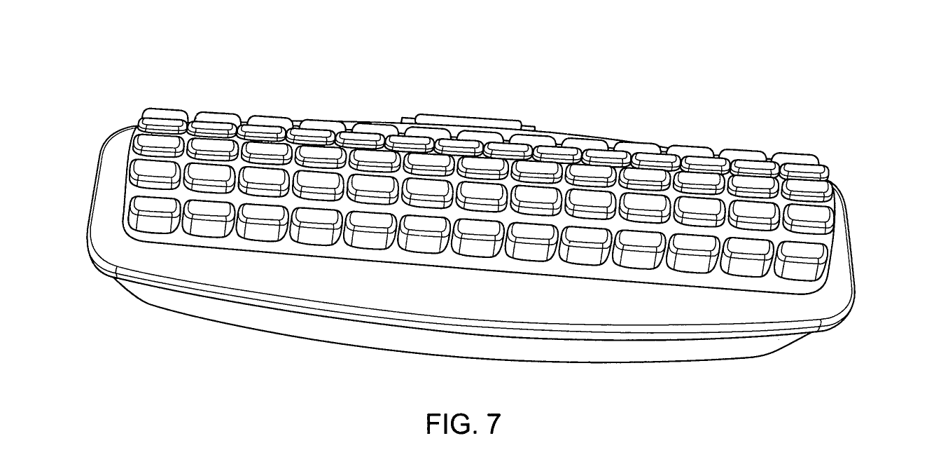

### Specific Configuration of Top Portion 18—FIGS. 3 and 7

46 living hinge of top portion 18 selectively mating with bottom portion 16
48 main part of top portion 18
50 female flange of top portion 18
52 perimeter of main part 48 of top portion 18

### DETAILED DESCRIPTION OF THE PREFERRED EMBODIMENTS

### Introductory

Referring now to the figures, in which like numerals indicate like parts, and particularly to FIGS. 1 and 2, the manual device of the embodiments of the present invention is shown generally at 10 for maximizing application of butter 12 to an ear of corn 14.

### Overall Configuration of the Manual Device 10

The overall configuration of the manual device 10 can best be seen in FIG. 3, and as such, will be discussed with reference thereto.

The manual device 10 includes a bottom portion 16, a top portion 18, and a butter applicator 20.

The bottom portion 16 is for resting on a support surface 22, is for carrying the butter 12, and is for rotatably carrying the ear of corn 14.

The butter applicator 20 is rotatably connected in the bottom portion 16, and is for maximizing the application of the butter 12 to the ear of corn 14 when the butter applicator 20 is rotated, which in turn rotates the ear of corn 14.

The top portion 18 is operatively connected to the bottom portion 16, is for maintaining the ear of corn 14 in the bottom portion 16 during rotation, and is for preventing the butter 12 from splashing during rotation.

### Specific Configuration of the Bottom Portion 16

The specific configuration of the bottom portion 16 can best be seen in FIGS. 4, 5, and 6, and as such, will be discussed with reference thereto.

The bottom portion 16 has a main part 24 and a male flange 26, and is, preferably, made from ceramics. The main part 24 of the bottom portion 16 is slender, elongated, semi-cylindrically shaped, and has a perimeter 28 and an interior surface 30. A lower part of the interior surface 30 of the main part 24 of the bottom portion 16 forms a trough 31 for carrying the butter 12.

The male flange 26 of the bottom portion 16 extends outwardly from around the perimeter 28 of the main part 24 of the bottom portion 16, and replaceably receives the top portion 16.

The bottom portion 16 further has a pair of opposing ends 32. Each opposing end of the pair of opposing ends 32 of the bottom portion 16 has a through slot 34 extending vertically therethrough.

An upper part of the interior surface 30 of the main part 24 of the bottom portion 16 has protrusions 36. The protrusions 36 of the upper part of the interior surface 30 of the main part 24 of the bottom portion 16 replicate kernels of corn.

The protrusions 36 are irregularly shaped so as to form irregularly-shaped protrusions 36, are disposed along the upper part of the interior surface 30 of the main part 24 of the bottom portion 16, and are for allowing the ear of corn 14 to be more uniformly buttered.

The protrusions 36 increase the interior surface 30 of the main part 24 of the bottom portion 16 for allowing a greater volume of the butter 12 to be available for coating the ear of corn 14.

The irregularly-shaped protrusions 36 have spacings 38 therebetween for facilitating greater contact with the ear of corn 14.

Since kernels on the ear of corn 14 themselves are irregularly shaped and spaced-apart from each other, only kernels on the ear of corn 14 themselves that are more highly elevated would come in contact with a hypothetical smooth surface. By making the irregularly shaped protrusions 36 on walls of the bottom portion 16, a greater number of contact points become available between the walls of the bottom portion 16 and the ear of corn 14.

### Specific Configuration of the Butter Applicator 20

The specific configuration of the butter applicator 20 can best be seen in FIGS. 3, 4, and 5, and as such, will be discussed with reference thereto.

The butter applicator 20 includes a brush 40. The brush 40 of the butter applicator 20 is disposed in the bottom portion 16, is for disposing in the butter 16, and is slender and elongated.

The brush 40 of the butter applicator 20 extends loosely from outward of one end 32 of the bottom portion 16 loosely to outward of the other end 32 of the bottom portion 16, so as to form a pair of laterally compressed ends 42 of the brush 40 of the butter applicator 20, respectively.

The pair of laterally compressed ends 42 of the brush 40 of the butter applicator 20 extend outward of the trough slots 34 of the pair of opposing ends 32 of the bottom portion 16, respectively.

The butter applicator 20 further includes a pair of handles 44. The pair of handles 44 of the butter applicator 20 are disposed on the pair of laterally compressed ends 42 of the brush 40 of the butter applicator 20, respectively, and are used to allow the brush 40 of the butter applicator 20 to be manually rotated. The pair of handles 44 of the butter applicator 20 replicate corn holders.

### Specific Configuration of the Top Portion 18

The specific configuration of the top portion 18 can best be seen in FIGS. 3 and 7, and as such, will be discussed with reference thereto.

The top portion 18 is optional and when used is operatively connected to the bottom portion 16, is for maintaining the ear of corn 14 in the bottom portion 16 during rotation, and prevents the butter 12 from splashing during rotation.

The top portion 18 has a main part 48 and a female flange 50, and is, preferably, made from plastic. The main part 48 of the top portion 18 is slender, elongated, semi-cylindrically shaped, and has a perimeter 52.

The female flange 50 of the top portion 18 extends outwardly from around the perimeter 52 of the main part 48 of the top portion 18, and replaceably receives the male flange 26 of the bottom portion 16 during use.

### Impressions

It will be understood that each of the elements described above, or two or more together, may also find a useful application in other types of constructions differing from the types described above.

While the embodiments of the present invention have been illustrated and described as embodied in a manual device for maximizing application of butter to an ear of corn, however, they are not limited to the details shown, since it will be understood that various omissions, modifications, substitutions, and changes in the forms and details of the embodiments of the present invention illustrated and their operation can be made by those skilled in the art without departing in any way from the spirit of the embodiments of the present invention.

Without further analysis the foregoing will so fully reveal the gist of the embodiments of the present invention that others can by applying current knowledge readily adapt them for various applications without omitting features that from the standpoint of prior art fairly constitute characteristics of the generic or specific aspects of the embodiments of the present invention.

The invention claimed is:

1. A manual device for maximizing application of butter to an ear of corn, comprising:
a) a bottom portion;
b) a top portion; and
c) a butter applicator;
wherein said bottom portion is for resting on a support surface;
wherein said bottom portion is for carrying the butter;
wherein said bottom portion is for rotatably carrying the ear of corn;
wherein said butter applicator is rotatably connected in said bottom portion;
wherein said butter applicator is for maximizing the application of the butter to the ear of corn when said butter applicator is rotated, which in turn rotates the ear of corn;
wherein said top portion is operatively connected to said bottom portion;
wherein said top portion is for maintaining the ear of corn in said bottom portion during rotation; and
wherein said top portion is for preventing the butter from splashing out during rotation.

2. The manual device of claim 1, wherein said bottom portion has:
a) a main part; and
b) a male flange.

3. The manual device of claim 1, wherein said bottom portion is made from ceramics.

4. The manual device of claim 2, wherein said main part of said bottom portion is:
a) slender;
b) elongated; and
c) semi-cylindrically shaped; and
wherein said main part of said bottom portion has:
a) a perimeter; and
b) an interior surface.

5. The manual device of claim 4, wherein a lower part of said interior surface of said main part of said bottom portion forms a trough for the butter.

6. The manual device of claim 4, wherein said male flange of said bottom portion extends outwardly from around said perimeter of said main part of said bottom portion; and
wherein said male flange of said bottom portion replaceably receives said top portion.

7. The manual device of claim 1, wherein said bottom portion has a pair of opposing ends.

8. The manual device of claim 7, wherein each opposing end of said pair of opposing ends of said bottom portion has a through slot extending vertically therethrough.

9. The manual device of claim 4, wherein an upper part of said interior surface of said main part of said bottom portion has protrusions; and
wherein said protrusions on said upper part of said interior surface of said main part of said bottom portion replicate kernels of corn.

10. The manual device of claim 9, wherein said protrusions are irregularly shaped;
wherein said protrusions are disposed along said upper part of said interior surface of said main part of said bottom portion; and
wherein said protrusions are for allowing the ear of corn to be more uniformly buttered.

11. The manual device of claim 9, wherein said protrusions increase area of said interior surface of said main part of said bottom portion for allowing a greater volume of the butter to be available for coating the ear of corn.

12. The manual device of claim 9, wherein said protrusions have spacings therebetween; and
wherein said spacings between said protrusions are for facilitating greater contact with the ear of corn.

13. The manual device of claim 1, wherein since kernels on the ear of corn themselves are irregularly shaped and spaced-apart from each other, only kernels on the ear of corn themselves that are more highly elevated would come in contact with a hypothetical smooth surface; and
wherein by making said protrusions on walls of said bottom portion, a greater number of contact points become available between the walls of said bottom portion and the ear of corn.

14. The manual device of claim 8, wherein said butter applicator includes a brush;
wherein said brush of said butter applicator is disposed in said bottom portion for disposing in the butter;
wherein said brush of said butter applicator is slender; and
wherein said brush of said butter applicator is elongated.

15. The manual device of claim 14, wherein said brush of said butter applicator extends loosely from outward of one end of said bottom portion loosely to outward of the other end of said bottom portion, so as to form a pair of laterally compressed ends of said brush of said butter applicator, respectively.

16. The manual device of claim 15, wherein said pair of laterally compressed ends of said brush of said butter applicator fit through said through slots of said pair of opposing ends of said bottom portion, respectively.

17. The manual device of claim 15, wherein said butter applicator includes a pair of handles; and
wherein said pair of handles of said butter applicator are disposed on said pair of laterally compressed ends of said brush of said butter applicator, respectively, so as to allow said brush of said butter applicator to be manually rotated.

18. The manual device of claim 17, wherein said pair of handles of said butter applicator replicate corn holders.

19. The manual device of claim 1, wherein said top portion is generally shaped as said bottom portion.

20. The manual device of claim 1, wherein said top portion is attached to said bottom portion by a living hinge.

21. The manual device of claim 2, wherein said top portion has:
a) a main part; and
b) a female flange;
wherein said main part of said top portion is:
a) slender;
b) elongated; and
c) semi-cylindrically shaped;
wherein said main part of said top portion has a perimeter.

22. The manual device of claim 21, wherein said main part of said top portion is made from plastic.

23. The manual device of claim 21, wherein said female flange of said top portion extends outwardly from around said perimeter of said main part of said top portion; and
wherein said female flange of said top portion replaceably receives interlockingly said male flange of said bottom portion.
